(19) United States
(12) Patent Application Publication
(10) Pub. No.: US 2026/0296621 A1
(43) Pub. Date: Oct. 1, 2026

(54) CYCLOIDAL MARINE PROPULSION SYSTEM

(71) Applicant: ABB Schweiz AG, Baden (CH)

(72) Inventors: Petri Pellinen, Helsinki (FI); Veli-Pekka Peljo, Helsinki (FI)

(21) Appl. No.: 19/555,305

(22) Filed: Mar. 3, 2026

(30) Foreign Application Priority Data
Mar. 28, 2025 (EP) 25166956.0

(51) Int. Cl. B63H 21/17; B63H 1/10; B63H 21/00; B63H 21/20

(52) U.S. Cl. CPC B63H 21/17; B63H 1/10; B63H 21/20; B63H 2021/003; B63H 2021/205

(57) ABSTRACT

A cycloidal marine propulsion system comprising a power source, an alternating current (AC) generator powered by the power source, and at least one rotating wheel with an AC motor and with a plurality of rotating blades attached to the at least one rotating wheel is provided. The frequency of the AC generator and a frequency of an electric current driving the AC motor is the same.

### CROSS-REFERENCE TO RELATED APPLICATIONS

This application claims priority to European Patent application No. 25166956.0, filed on Mar. 28, 2025, and titled “CYCLOIDAL MARINE PROPULSION SYSTEM”, the entire contents of which are hereby incorporated by reference.

### TECHNICAL FIELD

Embodiments of the present disclosure relate to a cycloidal marine propulsion system. Further embodiments relate to a method operating a marine vessel using a cycloidal marine propulsion system.

### BACKGROUND

Cycloidal marine propulsion systems provide an efficient way to propel marine vessels. Further, cycloidal marine propulsion systems allow for an improved maneuverability of marine vessels. In cycloidal marine propulsion systems, a rotating wheel with rotatable blades attached to the rotating wheel provides thrust. A direction and amount of the thrust may be controlled via a rotating speed of the rotating wheel and via a pitch of the rotatable blades.

Typically, the rotating wheel is electrically driven with the electric power for driving the electric wheel being supplied by a power source. However, between the power source and the electrically driven rotating wheel, a number of transmission steps lead to efficiency loses, exemplarily along transformers and frequency converters. Similarly, the transmission steps are associated with complex machinery and considerable costs.

### BRIEF DESCRIPTION

In the view of the foregoing, the present disclosure is directed to a cycloidal marine propulsion system, a marine vessel and a method of operating a marine vessel.

According to an aspect of the present disclosure, a cycloidal marine propulsion system comprising a power source, an alternating current (AC) generator powered by the power source, and at least one rotating wheel with an AC motor and with a plurality of rotating blades attached to the at least one rotating wheel is provided. The frequency of the AC generator and a frequency of an electric current driving the AC motor is the same.

According to another aspect of the present disclosure, a method of operating a marine vessel using a cycloidal marine propulsion system according to any of describes herein is provided.

According to another aspect of the present disclosure, a cycloidal marine propulsion system comprising a plurality of rotating wheels with at least two of the plurality of rotating wheels being provided with electric power by the power source is provided. The power source is a single power source.

According to some embodiments, the cycloidal marine propulsion system is configured to propel a marine vessel. In particular, the marine vessel may comprise a cycloidal marine propulsion system according to embodiments described herein. The marine vessel comprises seagoing or inland marine vessels. In particular, the marine vessel comprises ships and boats. In some embodiments, the marine vessel comprises ferries, in particular single-and double-ended ferries, cruise ships, water buses, yachts. In some embodiments, the marine vessel comprises offshore energy vessels, in particular service operation vessels (SOVs), cable laying vessels (CLVs), foundation installation vessels (FIVs), offshore construction (OCVs) and support vessels (OSVs), platform supply vessels (PSVs), and anchor-handling tug supply vessels (AHTS). In some embodiments, the marine vessel comprises research and survey vessels or other special purpose vessels. According to some embodiments, the marine vessel comprises merchant ships, in particular for transporting goods.

According to some embodiments, a plurality of rotating blades are attached to the rotating wheel. Typically, the plurality of rotating blades are electrically driven. In particular, an angle or pitch of the plurality of rotating blades may be adjusted individually. In some embodiments, the plurality of rotating blades are mechanically driven. In particular, the plurality of rotating blades are mechanically driven by the rotation of the rotating wheel. In other words, the position of the rotating wheel and a pitch of the blades may be mechanically linked. Exemplarily, the cycloidal marine propulsion system may comprise a Voith-Schneider propeller with mechanically driven rotating blades.

According to some embodiments, two, three, four, five, six, eight or more rotating blades may be attached to the rotating wheel. The rotating blades are rotatable with respect to the rotating wheel. In particular, the rotating blades are individually rotatable with respect to the rotating wheel. In other words, typically, each of the plurality of rotating blades can be controlled individually, in particular the pitch of each of the rotating blades can be controlled individually. For each of the rotating blades, the rotating wheel may comprise a rotating blade electric motor driving the respective rotating blade. In some embodiments, the pitch of the plurality of rotating blades may be adjusted with no angular restriction. In particular, the plurality of rotating blades may be rotatable by at least 360°. The rotating wheel comprises a plurality of recesses to receive the plurality of electrically driven rotating blades.

According to some embodiments, the cycloidal marine propulsion system comprises a power source. Typically, the power source comprises an internal combustion engine. In particular, the power source may comprise a diesel engine, exemplarily a two-stroke diesel engine or a four-stroke diesel engine. In some embodiments, the internal combustion engine may comprise a gas turbine. Typically, the power source operates at a low rotational speed, exemplarily, the power source operates at a rotational speed smaller than 500 rpm, smaller than 250 rpm or smaller than 150 rpm. In some embodiments, the power source comprises a battery and/or a fuel cell.

Typically, the power source is a single power source, and particularly a single internal combustion engine. In particular, at least 80%, at least 85%, at least 90% or at least 95% of a total continuous power of the power source is provided by the single power source. Typically, the power source has a power of at least 1 MW, at least 2 MW, at least 5 MW, or at least 8 MW. Higher power output power sources, and particularly internal combustion engines, are typically associated with a higher efficiency, particularly with a higher thermal efficiency. Accordingly, having a single power source as the power source is typically associated with a higher efficiency of the power source, particularly compared to a power source comprising a plurality of internal combustion engines.

Typically, the cycloidal marine propulsion system comprises a plurality of rotating wheels, particularly with at least two of the plurality of rotating wheels being provided with electric power by the power source. In some embodiments, the power source is a single power source. Exemplarily, the cycloidal marine propulsion system comprises 2, 3, 4 or more rotating wheels and the 2, 3, 4 or more rotating wheels are provided with electric power by the single power source. Having one single power source providing power to a plurality of rotating wheels may advantageously improve the efficiency of the cycloidal marine propulsion system and/or may reduce costs. In some embodiments, the installation space required for the power source may advantageously be reduced.

In some embodiments, the power source may comprise a first power source and a second power source. In particular, the first power source may provide electric power for a first plurality of rotating wheels and the second power source may provide electric power for a second plurality of rotating wheels. Having a plurality of power sources powering the plurality of rotating wheels, particularly with each of the plurality of power sources powering at least two of the plurality of rotating wheels, may advantageously provide redundancy in the cycloidal marine propulsion system.

According to some embodiments, the cycloidal marine propulsion system comprises an alternating current (AC) generator. The AC generator is powered by the power source. In particular, the AC generator typically comprises a generator shaft. The generator shaft is typically connected with the rotor of the AC generator. In particular, generator shaft is configured to transmit a torque of the power source to the rotor. Typically, the generator shaft is mechanically connected to a power source shaft, or a drive shaft, of the power source. In some embodiments, the cycloidal marine propulsion system comprises a mechanical gearbox, particularly a fixed-ratio gearbox, with the power source shaft acting as or being connected to a driving shaft of the mechanical gearbox and the generator shaft acting as or being connected to an output shaft of the mechanical gearbox. The AC generator typically comprises a permanent magnet generator or an induction generator. Typically, the AC generator is a low voltage generator. particularly, the voltage generated by the AC generator does not exceed 1200 V, 1000 V or 800 V. Exemplarily, the AC generator provides a voltage between 400 V and 690 V.

In some embodiments, the cycloidal marine propulsion system comprises at least two AC generators with the single power source powering the at least two AC generators. In particular, the power source shaft may be mechanically connected to the at least two AC generators, particularly to a generator shaft of each of the at least two AC generators. In some embodiments, the cycloidal marine propulsion system may comprise a gearing with a plurality of output drive shafts. Each of the plurality of output drive shafts may be mechanically connected to one of the at least two AC generators. In some embodiments, each of the at least two AC generators may provide electric power for one rotating wheel. In other words, for a plurality of rotating wheels, each of the plurality of rotating wheels may be electrically connected to a distinct AC generator of the at least two AC generators with all of the at least two AC generators being powered by a single power source.

According to some embodiments, the cycloidal marine propulsion system comprises a transmission gearing connecting the generator shaft and the power source shaft. According to some embodiments, the cycloidal marine propulsion system comprises a fluid coupling, or a mechanical clutch, connecting the power source, and particularly the power source shaft, and the AC generator, particularly the generator shaft. The fluid coupling may advantageously allow for a controlled start-up process of the cycloidal marine propulsion system. Particularly, the fluid coupling may advantageously avoid a shock loading in a start-up process of the cycloidal marine propulsion process and may reduce wear and tear of the cycloidal marine propulsion system.

In some embodiments, the fluid coupling comprises a mechanical locking for connecting the power source shaft of the power source and the generator shaft of the AC generator mechanically together. An application of the mechanical locking may be controlled by a controller of the cycloidal marine propulsion system, particularly based upon a power source parameter. Exemplarily, the mechanical locking may be applied once the power source reaches a stable operating frequency. The mechanical locking advantageously allows to avoid or to reduce slipping and to enhance the overall efficiency of the cycloidal marine propulsion system.

According to some embodiments, the AC generator is electrically connected to the AC motor AC-to-AC-converter-free for providing electric power to the AC motor. In other words, the electrical connection for transmitting the electric power from the AC generator to the AC motor is free of AC-to-AC-converters. In particular, the electrical connection is free of transformers, rectifiers, inverters and cycloconverters. In particular, the alternating current driving the AC motor has the same frequency as the alternating current provided by the AC generator. In other words, the frequency of the AC generator and the frequency of the electric current driving the AC motor may be the same. An electrical connection free of AC-to-AC-converters, and particularly free of frequency converters, may advantageously reduce or avoid electric stray currents exemplarily caused by common mode currents. Cost may be reduced due to a reduced need for bearing isolations and a reliability of bearings may be enhanced.

According to some embodiments, the AC generator comprises a plurality of generator poles, particularly a first number of generator poles. The first number of generator poles defines, inter alia, the frequency of the AC generator, in other words the frequency of the electric current generated by the AC generator. Typically, the AC motor comprises a plurality of motor poles, particularly a second number of motor poles. The second number of motor poles defines, inter alia, the frequency of a motor rotation of the AC motor. In other words, the second number of motor poles defines, inter alia, a rotation frequency of the at least one rotating wheel. Typically, a ratio between the first number of generator poles and the second number of motor poles defines a ratio of the frequency of the AC generator shaft and/or of the power source shaft and the rotation frequency of the at least one rotating wheel. In other words, the ratio between the first number of generator poles and the second number of motor poles may be considered as a transmission ratio. Overall, the AC generator and the AC motor being connected AC-to-AC-converter-free in combination with the first number of generator poles being different from the second number of motor poles may be considered as forming an electric shaft with an electric gear box.

In particular, the AC generator and the AC motor may be electrically connected via conductive electric power feeding cables and may allow for a gear ratio between the power source and the at least one rotating wheel without involving a mechanical transmission gear. An electric shaft with an electric gear box may advantageously allow to operate the power source and the rotating wheel at different, and particularly optimized, operating frequencies while maintaining a compact and efficient power transmission. Typically, the electric shaft with an electric gear box can advantageously replace a mechanic gear box and can advantageously enhance the efficiency of the cycloidal marine propulsion system. An electric shaft may advantageously allow for a more flexible arrangement of components of the propulsion system in the hull of a marine vessel. In particular, flexible electric power feeding cables replace rigid propeller shafts with the associated bearings.

In some embodiments, the AC generator comprises at least 2, at least 3, at least 4 or at least 10 generator poles. Typically, the AC generator comprises at most 20, at most 30, at most 40 or at most 50 generator poles. In particular, the AC generator comprises 2 to 40 generator poles. In some embodiments, the AC motor comprises at least 2, at least 3, at least 4 or at least 10 motor poles. Typically, the AC motor comprises at most 20, at most 30, at most 40 or at most 50 motor poles. In particular, the AC motor comprises 2 to 40 motor poles. Typically, the generator poles and/or the motor poles comprise permanent magnets.

In some embodiments, the first number of generator poles is different from the second number of motor poles. Typically, the ratio between the first number of generator poles and the second number of motor poles is from 0.05 to 20, from 0.1 to 10 or from 0.2 to 5. Exemplarily, the AC generator may rotate at 120 rpm and the AC motor, and accordingly the rotating wheel, may rotate at 40 rpm. In some embodiments, the first number of generator poles and the second number of motor poles are equal; in other words, the AC generator operates at the same frequency as the AC motor.

According to some embodiments, the cycloidal marine propulsion system comprises an auxiliary power unit (APU). Typically, the auxiliary power unit is configured to provide auxiliary power during a start-up process of the power source. In some embodiments, the APU is configured to provide power to the at least one rotating wheel without the power source operating. In other words, the marine vessel may be powered solely by the auxiliary power unit, particularly in a zero emission mode or full electric mode. The auxiliary power unit may comprise a battery, a fuel cell or an internal combustion engine. Typically, the auxiliary power unit has a power of at most 25%, at most 20%, at most 10%, or at most 5% of the total continuous power of the power source. In some embodiments, the auxiliary power unit may be configured to operate as a starter motor. In particular, the auxiliary power unit may be configured to rotate the generator shaft of the AC generator and/or the power source shaft of the power source. In other words, the electric current driving the rotating wheel may solely be produced by the AC generator, with the AC generator being driven by the power source and the auxiliary power unit. In some embodiments, the auxiliary power unit may be electrically connected to the AC motor parallelly. In particular, the auxiliary power unit may be configured to provide an alternating current to an electric network feeding the AC motor, in other words the electric shaft, independently of the AC generator.

Typically, for an auxiliary power unit comprising a battery and/or a fuel cell, the auxiliary power unit further comprises an inverter. In some embodiments, the inverter is configured to follow a frequency and a phase of the AC current driving the AC motor. In some embodiments, particularly for an auxiliary power unit comprising an internal combustion engine, the auxiliary power unit comprises an APU generator. The APU generator may be operated as an AC motor driving the AC shaft of the AC generator. In some embodiments, an APU generator shaft may be connected with the AC shaft via a gearing and/or via a clutch or fluid coupling.

Typically, an operation of the auxiliary power unit and an operation of the power source is controlled via a controller of the cycloidal marine propulsion system. Particularly, the controller of the cycloidal marine propulsion system may identify an operating mode of the cycloidal marine propulsion system and may control an operation of the auxiliary power unit and of the power source accordingly. Particularly, the controller may identify a power required and may control the power source and, if necessary, the auxiliary power unit, to provide the power required. Typically, the controller may induce an operation of the auxiliary power unit for a start-up process of the cycloidal marine propulsion system or for an operation without the power source operating, exemplarily in an environment with strict emission controls. In some embodiments, the operating mode may comprise the zero emission mode or the full electric mode and the controller may control the auxiliary power unit to solely provide the power required. Typically, the zero emission mode or the full electric mode may be employed in environments with strict emission standards, exemplarily in a port environment or in an environment with enhanced environment protection regulations.

In some embodiments, the cycloidal marine propulsion system comprises a second generator for generating an electric current using a rotation of the generator shaft of the AC generator. The rotation of the generator shaft of the AC generator may be caused by a rotation of the rotating wheel. In particular, the cycloidal marine propulsion system may be used as a generator, generating an electric current based upon a rotation of the rotating wheel. The rotation of the rotating wheel may be caused by a water current. In other words, the cycloidal marine propulsion system may be configured to operate in a hybrid mode, where the controller is configured to operate the cycloidal marine propulsion system in a current generating mode and in a propulsion generating mode. Particularly, the current generating mode may be associated with a braking setting of the cycloidal marine propulsion system. In some embodiments, the braking setting may comprise a speed regulation, exemplarily for wind assisted vessels.

Typically, the second generator comprises a second generator shaft. The second generator shaft is typically mechanically connected to the generator shaft of the AC generator. In particular, the second generator shaft may be mechanically connected to the generator shaft of the AC generator by a gearing and/or by a clutch, particularly by a mechanical clutch or a fluid coupling. In some embodiments, the second generator shaft and the generator shaft of the AC generator may be one part.

Typically, in the current generating mode, the electric current generated by the second generator may be employed to charge a battery. The electric energy charged in the battery during the current generating mode may be employed to propel the marine vessel using the auxiliary power unit. Particularly, the battery of the auxiliary power unit may be charged in the current generating mode. In some embodiments, the battery may be charged by the power source, in particular for operating scenarios where a reduced power or no power is required.

In some embodiments, the battery may be charged by the electric current flowing in the electric shaft. In particular, the battery may be electrically connected in parallel to the AC generator. Typically, the battery is electrically connected to the electric shaft, namely to the electric lines connecting the AC motor and the AC generator, via a converter, namely a rectifier and/or an inverter, system.

In some embodiments, the cycloidal marine propulsion system comprises a switchboard. Typically, the switchboard is arranged between a plurality of rotating wheels and the AC generator. The switchboard is typically configured to divide the electric current generated by the AC generator upon the plurality of rotating wheels. Typically, the switchboard is configured to variably divide the electric current upon the plurality of rotating wheels. Particularly, the controller of the cycloidal marine propulsion system may change a switchboard setting based upon a steering command. In some embodiments, the division of the electric current may be fixed. In effect, the switchboard may be described as acting as a gear box for the electric shaft.

Typically, a marine vessel is operated using a cycloidal marine propulsion system according to embodiments described herein. Particularly, the cycloidal marine propulsion system may be controlled by a propulsion control system and/or interface of the marine vessel. Exemplarily, a setpoint for a propulsion direction and/or speed may be provided to the controller of the cycloidal marine propulsion system.

According to some embodiments, operating the marine propulsion system may comprise starting the cycloidal marine propulsion system. Typically, starting the marine propulsion system may comprise setting a blade angle of the plurality of rotating blades in a minimum-thrust configuration. The minimum-thrust configuration may comprise a non-thrust configuration. The minimum thrust configuration may comprise blade angles of an angle of at most ±20° with respect to a blade angle theoretically associated with a minimum thrust. The method further comprises, typically subsequently to setting the blade angle, starting the AC generator such that the at least one rotating wheel starts rotating. Starting the AC generator may comprise starting the power source and/or starting the auxiliary power unit. Particularly during the starting of the AC generator, a frequency and/or a power of the AC generator may not be stable. The method further comprises gradually changing the blade angle of the plurality of rotating blades into an end position generating thrust. In particular, the end position may comprise a blade angle associated with a maximum thrust or with a thrust set point provided by the controller of the cycloidal marine propulsion system. Typically, the controller of the cycloidal marine propulsion system is configured to gradually change the blade angle of the plurality of rotating blades along a starting process of the AC generator. In other words, the blade angle is changed along the available power provided by the AC generator. In some embodiments, the blade angle is changed subsequently to reaching a stable power provided by the AC generator. In other words, the blade angle is changed after the starting process of the AC generator.

According to some embodiments, starting the cycloidal marine propulsion system comprises setting the blade angle of the plurality of rotating blades in a thrust-generating configuration, exemplarily in a maximum-thrust configuration. Typically, the AC generator and/or the power source are started gradually. Exemplarily, the rotational speed and/or the power of the power source is increased gradually. In other words, the starting process of the cycloidal marine propulsion system, and particularly of the thrust provided by the cycloidal marine propulsion system, is substantially defined by a starting process of the power source and the AC generator. In some embodiments, starting the cycloidal marine propulsion system comprises an electric start-up. In particular, the AC generator may supply a lower voltage to the cycloidal marine propulsion system. The voltage may increase during the electric start-up and may reach an operating voltage at an end of the electric start-up process.

According to some embodiments, operating the marine vessel comprises operating the rotating wheel at a constant rotation frequency. Particularly, subsequent to starting the cycloidal marine propulsion system, the power source and the AC generator typically operate at a substantially constant frequency. Accordingly, the electric current generated by the AC generator has a substantially constant frequency. Typically, for setting an amplitude and/or thrust of the cycloidal marine propulsion system, the blade angle of the plurality of rotating blades is adjusted. Operating the cycloidal marine propulsion system, and particularly the rotating wheel, at a constant rotation frequency allows to optimize the power source, the AC generator, the AC motor and/or the number of first poles and of second poles at an optimum efficiency. Exemplarily, the power source may be optimized for a particular operating frequency. Setting the thrust of the cycloidal marine propulsion system via the blade angle typically allows to quickly adapt the thrust of the cycloidal marine propulsion system upon changing requirements. Particularly, a direction of the thrust may be adapted in a short time.

Embodiments of the present disclosure provide an improved cycloidal marine propulsion system. In particular, cycloidal marine propulsion systems with an increased total propulsion efficiency are provided. The power source, the AC generator and the AC motor may be optimized in the design phase and may be chosen, and configured, at their respective efficiency optimum. Particularly, the power source may be a single power source with an increased efficiency compared to a plurality of smaller power sources. Cycloidal marine propulsion systems according to embodiments described herein have a reduced cost due to a reduced number of, particularly electrical, components. Exemplarily, cycloidal marine propulsion systems according to embodiments described herein can be provided without AC-to-AC converters. A reduced number of components may typically be associated with a reduced cost in manufacturing and in maintenance. The installation space required for the cycloidal marine propulsion system may be reduced and components of the cycloidal marine propulsion system may be arranged in the hull of the marine vessel more flexibly due to an electric shaft principle rather than mechanical shafts being used to transmit power from the power source to the rotating wheel.

Cycloidal marine propulsion system according to embodiments described herein may be employed as a modular system. In particular, an overall propulsion of the cycloidal marine propulsion system may be adjusted to requirements of a specific marine vessel by adapting a number and/or position of the rotating wheels. The electric shaft approach of embodiments described herein reduces the requirement for reengineering, particularly due to the lack of mechanical propeller shafts, and the associated bearings, connecting the power source with a propeller or rotating wheel.

### BRIEF DESCRIPTION OF DRAWINGS

The accompanying drawings relate to embodiments of the disclosure and are described in the following:

FIG. 1 schematically illustrates a cycloidal marine propulsion system according to the embodiments described herein;

FIG. 2 schematically illustrates a cycloidal marine propulsion system according to the embodiments described herein;

FIG. 3 schematically illustrates a cycloidal marine propulsion system according to the embodiments described herein;

FIG. 3a schematically illustrates the cycloidal marine propulsion system of FIG. 3 in an operating mode;

FIG. 3b schematically illustrates the cycloidal marine propulsion system of FIG. 3 in an operating mode;

FIG. 3c schematically illustrates the cycloidal marine propulsion system of FIG. 3 in an operating mode;

FIG. 3d schematically illustrates the cycloidal marine propulsion system of FIG. 3 in an operating mode;

FIG. 4 schematically illustrates a cycloidal marine propulsion system according to the embodiments described herein;

FIG. 5 schematically illustrates a cycloidal marine propulsion system according to the embodiments described herein;

FIG. 6 schematically illustrates a cycloidal marine propulsion system according to the embodiments described herein;

FIG. 7 schematically illustrates a cycloidal marine propulsion system according to the embodiments described herein; and

FIG. 8 schematically illustrates a method of operating a marine vessel according to the embodiments described herein.

### DETAILED DESCRIPTION

Reference will now be made in detail to the various embodiments of the disclosure, one or more examples of which are illustrated in the figures. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield a further embodiment. It is intended that the description includes such modifications and variations. In the figures, elements may be depicted with exaggerated dimensions to improve the comprehensibility of the detailed description of embodiments. In particular, relations of lengths and widths of components shown may distorted. Further, some elements may be depicted with enlarged dimensions while other elements in the same figure are depicted, relatively, with reduced dimensions.

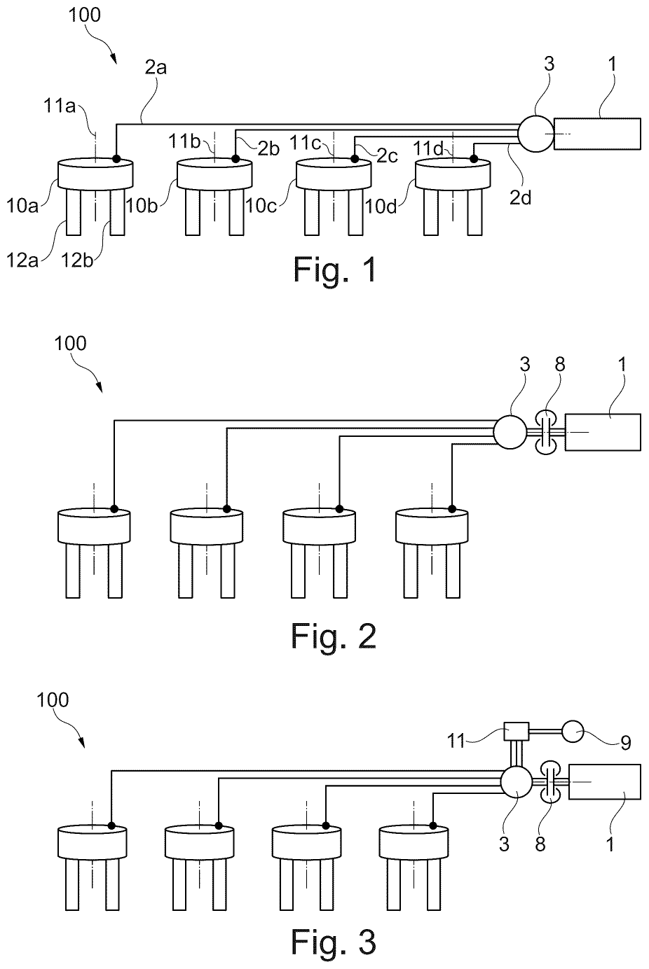

FIG. 1 schematically illustrates a cycloidal marine propulsion system 100. The cycloidal marine propulsion system 100 comprises a power source 1, an alternating current (AC) generator 3 and a plurality of rotating wheels 10a, 10b, 10c, 10d. Each of the plurality of rotating wheels 10a, 10b, 10c, 10d comprises a plurality of rotating blades 12a, 12b. In the figures, for each of the plurality of rotating wheels 10a, 10b, 10c, 10d, two rotating blades 12a, 12b are illustrated. However, typically, each of the rotating wheels 10a, 10b, 10c, 10d comprises more than two rotating blades 12a, 12b, particularly 4, 5, 6 or more rotating blades. Each of the plurality of rotating wheels 10a-10d rotates with respect to a respective rotating wheel rotation axis 11a, 11b, 11c, 11d.

The power source 1 is mechanically connected to the AC generator 3. Particularly a rotating shaft of the power source 1 is mechanically connected to a generator shaft of the AC generator 3. The AC generator 3 is electrically connected to the plurality of rotating wheels 10a-10d, and particularly to AC motors of the plurality of rotating wheels 10a-10d, via electric power feeding cables 2a, 2b, 2c, 2d. Each of the electric power feeding cables 2a, 2b, 2c, 2d may be considered as an electric shaft configured to transmit electric power from the AC generator to the plurality of rotating wheels 10a-10d.

In FIG. 2, the cycloidal marine propulsion system 100 further comprises a coupling 8 or clutch 8 connecting the power source 1 and the AC generator 3. The coupling 8 is configured to allow disconnecting and connecting the generator shaft from the rotating shaft of the power source 1. The coupling 8 typically is a fluid coupling 8, that may comprise a mechanical locking mechanism.

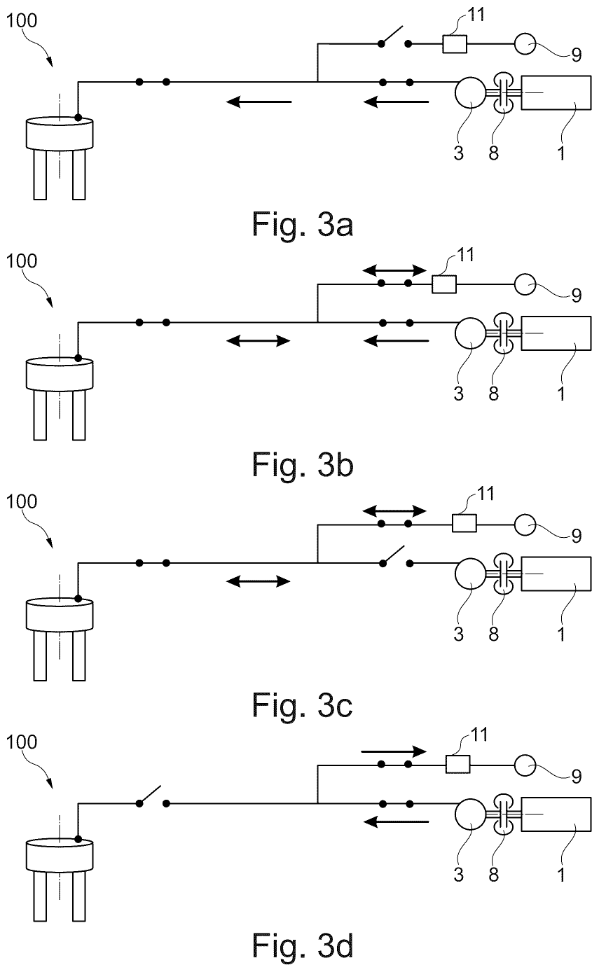

In FIG. 3, the cycloidal marine propulsion system 100 further comprises a converter 11 and a battery 9. The converter 11 is configured to convert an alternating current (AC) into a direct current (DC) and/or vice versa. Thus, the converter 11 comprises a rectifier and/or an inverter. The battery 9 is electrically connected to the AC generator 3 via the converter 11. The battery 9 is, via the converter 11, configured to be charged by an electric current flowing between the AC generator 3 and the plurality of rotating wheels. The battery 9 may provide a current to operate the plurality of rotating wheels. The battery 9 may described as being arranged electrically parallelly to the AC generator 3. In embodiments not shown in the figures, the battery 9 may be replaced or complemented with a fuel cell.

In FIG. 3a-3d, different configurations of the cycloidal marine propulsion system of FIG. 3 are shown. For simplicity, in FIG. 3a-3d, only one rotating wheel is depicted. In FIG. 3a-3d, arrows schematically depict the flow of power between the different components of the cycloidal marine propulsion system. However, the configurations of FIG. 3a-3d are applicable to a plurality of rotating wheels as well. Exemplarily, for each of the plurality of rotating wheels, the same configuration may be applied or a combination of the configurations of FIG. 3a-3d may be applied.

In FIG. 3a, the battery 9 and the converter 11 are disconnected from the rotating wheel and from the AC generator 3. The configuration of FIG. 3a may be described as power source mode, with only the power source 1 driving the rotating wheel. Thus, the configuration of FIG. 3a is the configuration as shown in FIGS. 1 and 2. In FIG. 3b, the battery 9 is connected via the converter 11 to the rotating wheel, and the AC generator 3 is connected to the rotating wheel. The configuration of FIG. 3b may be described as a hybrid or boost mode with auxiliary power being provided by the battery 9. The battery 9 may be charged by excess power of the AC generator 3. In FIG. 3c, the power source 1 and the AC generator 3 are disconnected from the rotating wheel. The battery 9 solely provides power to the rotating wheel. The battery 9 may be charged by the rotating wheel, exemplarily in a braking operation. The configuration of FIG. 3c may be described as a full electric mode or zero emission mode. For the rotating wheel charging the battery, the configuration of FIG. 3c may also be described as generating mode. In FIG. 3d, the rotating wheel is disconnected from the battery 9 and from the AC generator 3. The battery 9 is charged by the power source 1 via the AC generator 3 and the converter 11. The configuration of FIG. 3d may be described as a charging mode.

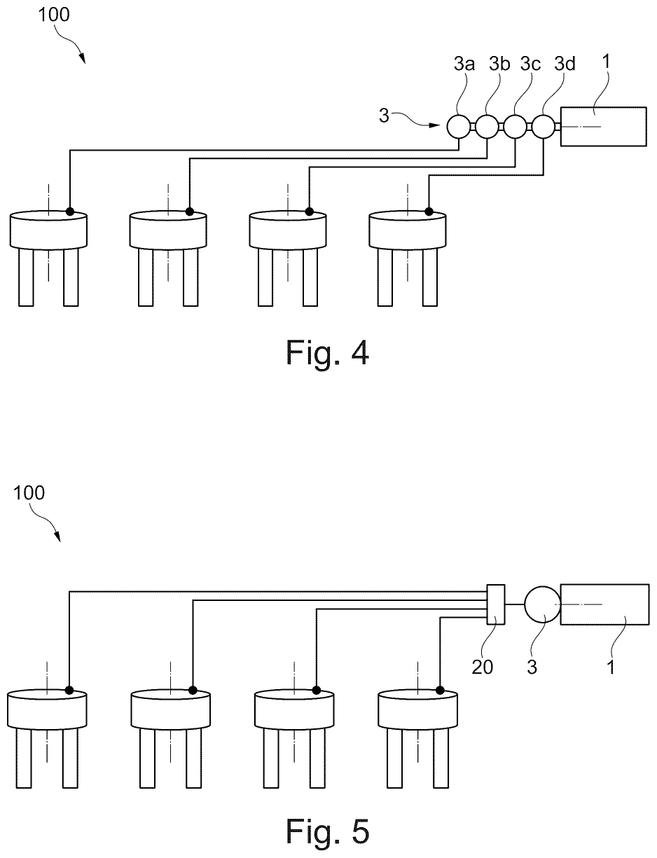

In FIG. 4, the AC generator 3 comprises a plurality of individual generators 3a, 3b, 3c, 3d. The plurality of individual generators 3a-3d is connected to the plurality of rotating wheels. Each rotating wheel is connected to one of the individual generators 3a-3d. Each of the individual generators 3a-3d is connected to one of the rotating wheels. The plurality of individual generators 3a-3d is mechanically connected to the power source 1. The power source 1 drives the plurality of individual generators 3a-3d, particularly via the power source shaft. The embodiment of FIG. 4 is particularly combinable with the embodiments shown in FIG. 3. Exemplarily one, a plurality of or all of the individual generators 3a-3d may be complemented with a battery and converter as shown in FIG. 3.

In FIG. 5, the cycloidal marine propulsion system 100 further comprises an electric switchboard 20. The switchboard 20 is configured to distribute the electric current generated by the AC generator 3 to the plurality of rotating wheels. The switchboard 20 may be configured to variably distribute the electric current generated by the AC generator 3 to the plurality of rotating wheels.

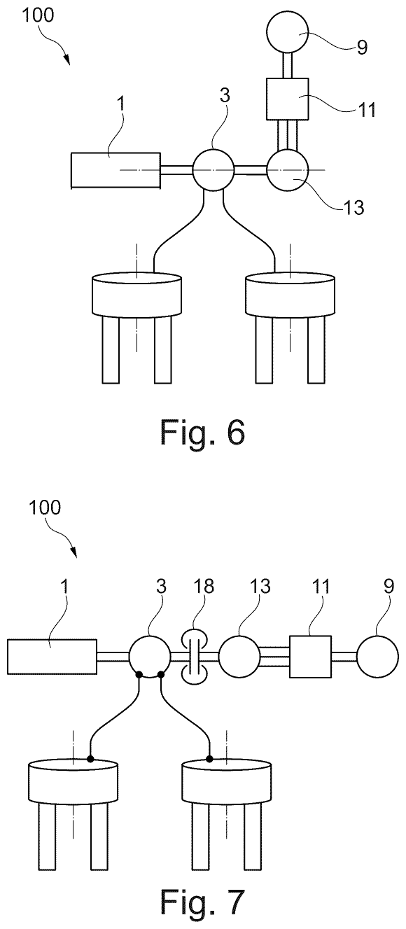

In FIG. 6, the cycloidal marine propulsion system 100 further comprises a second AC generator 13. The second AC generator 13 is mechanically connected to the AC generator 3 and the power source 1. Particularly, a second AC generator shaft is mechanically connected to a generator shaft of the AC generator 3. The cycloidal marine propulsion system 100 comprises an auxiliary power unit. The auxiliary power unit comprises the converter 11 and the battery 9. The second AC generator 13 may be configured to provide an additional power to the AC generator 3. Namely, it may be configured to provide an additional power to the rotating wheels. Additionally, or alternatively, the second AC generator 13 may be configured to receive an energy from the AC generator 3, in particular for the AC generator 3 operating in a motor mode driven by at least one rotating wheel. In other words, the second AC generator, the converter 11 and the battery 9 may act as a hybrid propulsion module. In embodiments not shown in the figures, the auxiliary power unit may comprise a fuel cell or an internal combustion engine.

In FIG. 7, the second AC generator 13 is connected to the AC generator 3 by a second coupling 18. The second coupling 18 typically is a fluid coupling 18, that may comprise a mechanical locking mechanism. The second coupling 18 is configured to allow disconnecting and connecting of the second AC generator shaft from the AC generator shaft and/or from the rotating shaft of the power source 1.

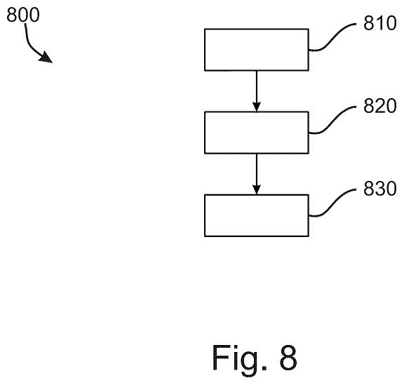

In FIG. 8, a method 800 of operating a marine vessel using a cycloidal marine propulsion system is schematically shown. The method 800 comprises setting 810 a blade angle of the plurality of rotating blades in a minimum-thrust configuration. The method 800 further comprises starting 820 an AC generator of the cycloidal marine propulsion system such that the at least one rotating wheel starts rotating. The method 800 further comprises gradually changing 830 the blade angle of the plurality of rotating blades into an end position generating thrust. In FIG. 8, the blade angle is changed 830 subsequently to starting 820 the AC generator. In embodiments not shown in the figures, starting 820 of the AC generator and gradually changing 830 the blade angle may be performed parallelly and particularly in a synchronized manner.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A cycloidal marine propulsion system comprising a power source, an alternating current (AC) generator powered by the power source, and at least one rotating wheel with an AC motor and with a plurality of rotating blades attached to the at least one rotating wheel, wherein a frequency of the AC generator and a frequency of an electric current driving the AC motor are the same.

2. The cycloidal marine propulsion system of claim 1, wherein the AC generator is electrically connected to the AC motor AC-to-AC-converter-free and configured to provide electric power to the AC motor.

3. The cycloidal marine propulsion system of claim 1, wherein:
the cycloidal marine propulsion system comprises a plurality of rotating wheels,
at least two of the plurality of rotating wheels are provided with electric power by the power source, and
the power source is a single power source.

4. The cycloidal marine propulsion system of claim 1, further comprising a fluid coupling connecting the power source and the AC generator.

5. The cycloidal marine propulsion system of claim 4, wherein the fluid coupling comprises a mechanical locking configured to mechanically connect a power source shaft of the power source and a generator shaft of the AC generator together.

6. The cycloidal marine propulsion system of claim 1, wherein the power source comprises a two-stroke diesel engine.

7. The cycloidal marine propulsion system of claim 1, further comprising an auxiliary power unit configured to provide additional power to the at least one rotating wheel during a controlled start-up process of the cycloidal marine propulsion system.

8. The cycloidal marine propulsion system of claim 7, wherein the auxiliary power unit comprises at least one of a battery and a fuel cell.

9. The cycloidal marine propulsion system of claim 1, further comprising a second generator configured to generate an electric current using a rotation of a generator shaft of the AC generator, wherein a rotation of the at least one rotating wheel causes the rotation of the generator shaft.

10. The cycloidal marine propulsion system of claim 3, wherein the cycloidal marine propulsion system comprises at least two AC generators powered by the single power source.

11. The cycloidal marine propulsion system claim 3, further comprising an electric switchboard configured to variably distribute electric power provided by the AC generator to the plurality of rotating wheels.

12. A marine vessel comprising a cycloidal marine propulsion system, wherein the cycloidal marine propulsion system comprises a power source, an alternating current (AC) generator powered by the power source, and at least one rotating wheel with an AC motor and with a plurality of rotating blades attached to the at least one rotating wheel, wherein a frequency of the AC generator and a frequency of an electric current driving the AC motor are the same.

13. A method for operating a marine vessel using a cycloidal marine propulsion system, wherein the cycloidal marine propulsion system comprises a power source, an alternating current (AC) generator, and at least one rotating wheel with an AC motor and with a plurality of rotating blades attached to the at least one rotating wheel, the method comprising:
powering the alternating current (AC) generator by the power source; and
setting a frequency of the AC generator the same as a frequency of an electric current driving the AC motor.

14. The method of claim 13, further comprising starting the cycloidal marine propulsion system, wherein starting the cycloidal marine propulsion system comprises:
setting a blade angle of the plurality of rotating blades in a minimum-thrust configuration;
starting the AC generator such that the at least one rotating wheel starts rotating; and
gradually changing the blade angle of the plurality of rotating blades into an end position generating thrust.

15. The method of claim 13, further comprising:
operating the rotating wheel at a constant rotation frequency; and
setting a thrust of the cycloidal marine propulsion system via a blade angle of the plurality of rotating blades.

16. The cycloidal marine propulsion system of claim 3, wherein the plurality of rotating wheels are provided with electric power by the AC generator that is powered by the single power source.

17. The cycloidal marine propulsion system of claim 7, wherein the auxiliary power unit is configured to perform at least one of:
provide power to the at least one rotating wheel independently from the power source; and
receive power from the at least one rotating wheel.

18. The method of claim 13, further comprising:
electrically connecting the AC generator to the AC motor AC-to-AC-converter-free; and
providing electric power to the AC motor by the AC generator.

19. The method of claim 13, wherein the cycloidal marine propulsion system comprises a plurality of rotating wheels, the method further comprising:
providing electric power to at least two of the plurality of rotating wheels by the power source, wherein the power source is a single power source.

20. The method of claim 13, further comprising:
providing a fluid coupling connecting the power source and the AC generator.
